(19) United States
(12) Patent Application Publication
(10) Pub. No.: US 2014/0111627 A1
(43) Pub. Date: Apr. 24, 2014

(54) MULTI-VIEWPOINT IMAGE GENERATION DEVICE AND MULTI-VIEWPOINT IMAGE GENERATION METHOD

(71) Applicant: PANASONIC CORPORATION, Osaka (JP)

(72) Inventor: Tomohide Ishigami, Osaka (JP)

(21) Appl. No.: 14/126,678

(22) PCT Filed: Jun. 19, 2012
(86) PCT No.: PCT/JP2012/003975

§ 371 Date: Dec. 16, 2013

(30) Foreign Application Priority Data
Jun. 20, 2011 (JP) 2011-136639

(51) Int. Cl. H04N 13/04

(52) U.S. Cl. CPC H04N 13/0402
USPC 348/51

(57) ABSTRACT

An image acquirer acquires paired left and right viewpoint images. A disparity calculator calculates a disparity between the left and right viewpoint images. A display properties memory stores naked-eye stereoscopic display properties such as recommended disparity values and a cross-talk rate. A disparity analyser reads the naked-eye stereoscopic display properties from the display properties memory and uses these properties to perform a disparity adjustment on the left and right viewpoint images. A multi-viewpoint image generator uses the disparity as adjusted by the disparity analyser to generate a multi-viewpoint image by performing a shift on each pixel of the left and right viewpoint images.

### TECHNICAL FIELD

The present invention relates to technology for generating a multi-viewpoint image for a naked-eye stereoscopic display from paired left and right viewpoint images.

### BACKGROUND ART

Stereoscopic display varieties include glasses-using displays in which 3D glasses are used, as well as naked-eye stereoscopic displays in which a parallax barrier or a lenticular lens is used. Content displayed by a glasses-using stereoscopic display is made up of paired left and right images. In contrast, content displayed by a naked-eye stereoscopic display is made up of multi-viewpoint images, preventing pseudo-stereoscopy according to the viewing position.

A current stereoscopic display is likely to be a glasses-using display. As such, current 3D content is likely configured using paired left and right viewpoint images. These images are insufficient as 3D content for a naked-eye stereoscopic display requiring a multi-viewpoint image.

In response to this issue, technology for generating a multi-viewpoint image from paired left and right viewpoint images has been used to generate a multi-viewpoint image intended for use by a naked-eye stereoscopic display. Patent Literature 1 discloses technology as follows. First, stereo matching is used to compute an inter-pixel distance for each pixel of the paired left and right viewpoint images. Then, either interpolation or extrapolation is performed using the inter-pixel distance, and the multi-viewpoint image is generated therefrom.

### CITATION LIST

### Patent Literature

### [Patent Literature 1]

Japanese Patent Application Publication No. 2009-124308

### SUMMARY OF INVENTION

### Technical Problem

However, when a multi-viewpoint image generated according to the aforementioned conventional technology is displayed on the naked-eye stereoscopic display, problems such as optical fatigue and stereoscopic fusion difficulties may occur.

In consideration of the above, the present invention aims to provide a multi-viewpoint image generation device that generates a multi-viewpoint image suited to display on a naked-eye stereoscopic display.

### Solution to Problem

In order to solve the above-described problem, a multi-viewpoint image generation device pertaining to the present disclosure generates a multi-viewpoint image for a naked-eye stereoscopic display, the multi-viewpoint image generation device comprising: an image acquirer acquiring paired left and right viewpoint images; a disparity calculator calculating a disparity between the paired left and right viewpoint images; a display properties memory storing a cross-talk rate or a recommended disparity for the naked-eye stereoscopic display as naked-eye stereoscopic display properties; a disparity analyser adjusting the disparity calculated by the disparity calculator using the naked-eye stereoscopic display properties; a multi-viewpoint image generator generating the multi-viewpoint image by shifting each pixel of the paired left and right viewpoint images, using the disparity as adjusted by the disparity analyser; a viewpoint compositor compositing the multi-viewpoint image; and an output unit outputting a composite image, obtained through the compositing by the viewpoint compositor, to the naked-eye stereoscopic display.

### Advantageous Effects of Invention

According to a multi-viewpoint image generation device pertaining to an aspect of the disclosure, naked-eye stereoscopic display properties are stored in advance and used to adjust a disparity calculated by a disparity calculator. Thus, a multi-viewpoint image is generated with a disparity appropriate to the naked-eye stereoscopic display, enabling a user to view stereoscopic video with image fusion across the full screen without experiencing optical fatigue or stereoscopic fusion difficulties.

### BRIEF DESCRIPTION OF DRAWINGS

FIG. 1 illustrates the configuration of a viewpoint generation device pertaining to Embodiment 1.

FIG. 2 illustrates the operations of a disparity calculator pertaining to Embodiment 1.

FIG. 3 illustrates an example of display properties stored in Embodiment 1.

FIGS. 4A and 4B illustrate the operations of a disparity analyser pertaining to Embodiment 1.

FIGS. 5A and 5B illustrate the operations of a viewpoint generator pertaining to Embodiment 1.

FIG. 6 illustrates an example of viewpoint generation actively using the L and R images, pertaining to Embodiment 1.

FIGS. 7A and 7B illustrate viewpoint generation pertaining to Embodiment 1, taking a dominant eye into consideration.

FIG. 8 illustrates the operations of a viewpoint compositor pertaining to Embodiment 1.

FIG. 9 is a flowchart of the overall operations performed by a multi-viewpoint image generation device pertaining to an Embodiment of the present disclosure.

FIG. 10 is a detailed flowchart of a disparity adjustment process.

FIG. 11 is a flowchart of the details of a multi-viewpoint image generation process.

FIG. 12 is a flowchart of the details of a variant multi-viewpoint image generation process.

FIG. 13 illustrates the configuration of a viewpoint generation device pertaining to Embodiment 2.

FIGS. 14A and 14B illustrate a variant pertaining to Embodiment 2, in which depth information is converted into a disparity value.

FIG. 15 is a flowchart illustrating the overall operations performed by a multi-viewpoint image generation device pertaining to Embodiment 2.

### DESCRIPTION OF EMBODIMENTS

(Overview of Basic Aspects of the Invention)

First, the basic aspects of the present invention are described.

In comparison to a glasses-using stereoscopic display, the naked-eye stereoscopic display typically has a higher cross-talk rate as the left and right viewpoint image combine. Thus, when a disparity value intended for a Blu-ray 3D viewpoint (i.e., inter-pixel distance between viewpoints spaced out by pixels) is used as-is on a large screen, image fusion does not occur, producing double imaging and optical fatigue as well as ineffective stereoscopy.

As a result of cutting-edge research, the experimenter has realised that the multi-viewpoint generation system disclosed in Patent Literature 1 generates the viewpoint images using interpolation or extrapolation of the inter-pixel distance according to the location of the viewpoint, and that as such, a large disparity difference occurs between scenes, which causes double imaging where image fusion does not occur, and produces the optical fatigue and ineffective stereoscopy.

That is, within the multi-viewpoint image, when the viewpoint images viewed by the left eye and the right eye are largely disparate, image fusion does not occur in the viewer's brain, leading to noise such as flickering and ultimately to optical fatigue.

In consideration of the above, the inventor arrived at the following invention.

(Outline of Aspects)

In one aspect, a multi-viewpoint image generation device generating a multi-viewpoint image for a naked-eye stereoscopic display, the multi-viewpoint image generation device comprising: an image acquirer acquiring paired left and right viewpoint images; a disparity calculator calculating a disparity between the paired left and right viewpoint images; a display properties memory storing a cross-talk rate or a recommended disparity for the naked-eye stereoscopic display as naked-eye stereoscopic display properties; a disparity analyser adjusting the disparity calculated by the disparity calculator using the naked-eye stereoscopic display properties; a multi-viewpoint image generator generating the multi-viewpoint image by shifting each pixel of the paired left and right viewpoint images, using the disparity as adjusted by the disparity analyser; a viewpoint compositor compositing the multi-viewpoint image; and an output unit outputting a composite image, obtained through the compositing by the viewpoint compositor, to the naked-eye stereoscopic display.

According to the above configuration, naked-eye stereoscopic display properties are stored in advance and used to adjust a disparity calculated by a disparity calculator. Thus, the naked-eye stereoscopic display enables a user to view stereoscopic video with image fusion across the full screen without experiencing optical fatigue or stereoscopic fusion difficulties.

In another aspect, the disparity analyser further performs, on a given pixel, a local adjustment to the disparity as adjusted using the naked-eye stereoscopic display properties, according to a difference in disparity between the given pixel and a peripheral pixel in the vicinity of the given pixel.

According to this configuration, the disparity contrast is adjustable according to the difference in disparity between the pixel subject to processing and the peripheral pixel in the vicinity thereof. Thus, a multi-viewpoint image is generated with intensified solidity.

In a further aspect, in the local adjustment, the disparity analyser intensifies the difference in disparity when the difference in disparity between the given pixel and the peripheral pixel in the vicinity of the given pixel is less than a predetermined value, and weakens the difference in disparity when the difference in disparity between the given pixel and the peripheral pixel in the vicinity of the given pixel is greater than the predetermined value.

According to this configuration, the stereoscopy is weakened by decreasing a large difference in disparity between proximate pixels, and is strengthened by increasing a small difference in disparity between proximate pixels. Accordingly, a multi-viewpoint image with enhanced solidity is provided to the user.

In an alternate aspect, the disparity analyser adjusts the disparity such that a span of the disparity calculated by the disparity calculator between a top X % and a bottom Y % is constrained within a range of the recommended disparity for the naked-eye stereoscopic display.

According to this configuration, the disparity is adjusted such that a span of the disparity between the top X % and the bottom Y % of the disparity is constrained within the range of recommended disparity values for the naked-eye stereoscopic display. As such, a multi-viewpoint image is generated with a disparity appropriate for the naked-eye stereoscopic display. Also, when a protrusion value is present in the 3D content, the disparity is made appropriately adjustable without affecting the protrusion value of the disparity.

In an additional aspect, the disparity analyser varies a value of X and a value of Y in accordance with a quantity of pixels having a near-zero disparity.

Over the entire screen, a wide screen surface area is available for fusion and as such, the presence of a portion with strong disparity is not likely to be noticed within the screen as a whole. Thus, according to the above configuration, adjusting the disparity in the vicinity of the screen surface area enables the disparity to be adjusted so as to be better suited to the user.

In another alternate aspect, the disparity analyser varies a value of X and a value of Y in accordance with an amount of inter-frame motion in one or both of the paired left and right viewpoint images.

When there is a large amount of motion between consecutive frames, the presence of a portion with strong disparity is not likely to be noticed within the screen as a whole. Thus, according to the above configuration, adjusting the disparity in response to the amount of displacement between frames enables adjustments to the disparity that are more appropriate for the user.

In a further alternate aspect, the disparity analyser adjusts the disparity such that a respective maximum value and minimum value of the disparity calculated by the disparity calculator are constrained within the range of the recommended disparity for the naked-eye stereoscopic display.

According to this configuration, the disparity is adjusted such that the maximum value and the minimum value of the disparity are constrained within the range of recommended disparity values for the naked-eye stereoscopic display. As such, a multi-viewpoint image is generated with a disparity appropriate for the naked-eye stereoscopic display.

In another additional aspect, the image acquirer acquires a first cross-talk rate estimated for a case where the paired left and right viewpoint images are displayed on a typical stereoscopic display, and the disparity analyser compares the first cross-talk rate to a second cross-talk rate stored in the display properties memory for the naked-eye stereoscopic display, and adjusts the disparity according to a ratio of the first cross-talk rate and the second cross-talk rate.

According to this configuration, given that the cross-talk rate is generally largely proportional to the recommended forward depth and to the recommended rearward depth, adjusting the disparity according to a ratio of a first cross-talk rate estimated for the stereoscopic display and a second cross-talk rate for the naked-eye stereoscopic display enables a multi-viewpoint image having a disparity that is suited to the naked-eye stereoscopic display.

In a further additional aspect, the disparity analyser computes a factor for applying a multiplication to the disparity calculated by the disparity calculator, such that the span of the disparity between the top X % and the bottom Y % is constrained within the range of the recommended disparity for the naked-eye stereoscopic display, and the multi-viewpoint image generator uses the factor computed by the disparity analyser to make a selection from among a plurality of multi-viewpoint image generation patterns employing the paired left and right viewpoint images as a portion of the multi-viewpoint image, and generates the multi-viewpoint image using the selected multi-viewpoint image generation pattern.

According to the above configuration, a multi-viewpoint image is generated with a disparity suited to the naked-eye stereoscopic display, based on a pair of left and right viewpoint images.

In yet another aspect, the multi-viewpoint image generator references dominant eye information for a user, and makes the selection of the multi-viewpoint image generation pattern such that within the multi-viewpoint image, the paired left and right viewpoint images are more frequently allocated as viewpoint images corresponding to a dominant eye for the user.

According to the above configuration, viewpoint generation is performed according to dominant eye information such that the dominant eye views left and right source images, thus enabling a multi-viewpoint image to be generated such that stereoscopy is more easily accomplished with full-screen image fusion.

In yet a further aspect, the disparity analyser sets a centre of interest at a central position in a pixel group having a near-zero disparity calculated by the disparity calculator, and performs the local disparity adjustment in accordance with a distance from the centre of interest to the given pixel subject to processing.

According to the above configuration, the disparity is weakened in a focus area of the screen where the user is more sensitive to stereoscopic solidity, and the disparity is strengthened in an area distant from the focus area of the screen where the user is less sensitive to the stereoscopic solidity.

In yet another alternate aspect, a multi-viewpoint image generation device generating a multi-viewpoint image for a naked-eye stereoscopic display, the multi-viewpoint image generation device comprising: an image acquirer acquiring paired left and right viewpoint images; a depth map acquirer acquiring a depth map indicating a depth for individual pixels of the paired left and right viewpoint images; a display properties memory storing a cross-talk rate or a recommended disparity for the naked-eye stereoscopic display as naked-eye stereoscopic display properties; a disparity analyser adjusting a disparity between the paired left and right viewpoint images defined by the depth indicated in the depth map, using the naked-eye stereoscopic display properties; a multi-viewpoint image generator generating a multi-viewpoint image by shifting each pixel of the paired left and right viewpoint images, using the disparity as adjusted by the disparity analyser; a viewpoint compositor compositing the multi-viewpoint image; and an output unit outputting a composite image obtained from compositing by the viewpoint compositor to the naked-eye stereoscopic display.

According to the above configuration, a depth map representing the depth of each pixel in the paired left and right viewpoint images is used to generate the multi-viewpoint image having a disparity suited to the naked-eye stereoscopic display. Thus, the naked-eye stereoscopic display enables a user to view stereoscopic video with image fusion across the full screen without experiencing optical fatigue or stereoscopic fusion difficulties.

In another aspect, the disparity analyser further performs, on a given pixel, a local adjustment to the disparity as adjusted using the naked-eye stereoscopic display properties, according to a difference in disparity between the given pixel and a peripheral pixel in the vicinity of the given pixel.

According the above configuration, when performing the disparity adjustment using the depth map, the disparity contrast is adjustable according to the difference in disparity between the pixel subject to processing and the neighbouring pixels thereof. Thus, a multi-viewpoint image is generated with intensified solidity.

In a further aspect, the disparity analyser adjusts the disparity such that a span of the disparity defined by the depth indicated in the depth map between the top X % and a bottom Y % is constrained within a range of the recommended disparity for the naked-eye stereoscopic display.

According to the above configuration, when performing the disparity adjustment using the depth map, the disparity is adjusted such that the top X % and the bottom Y % of the disparity are constrained within the range of recommended disparity values for the naked-eye stereoscopic display. As such, a multi-viewpoint image is generated with a disparity appropriate for the naked-eye stereoscopic display. Also, when a protrusion value is present in the 3D content, the disparity is made appropriately adjustable without affecting the protrusion value of the disparity.

In a further aspect, a multi-viewpoint image generation device pertaining to the disclosure generates a multi-viewpoint image for a naked-eye stereoscopic display, the multi-viewpoint image generation device comprising: an image acquirer acquiring paired left and right viewpoint images; a disparity calculator calculating a disparity between a left viewpoint and a right viewpoint, from the paired left and right viewpoint images; a display properties memory storing a cross-talk rate or a recommended disparity for the naked-eye stereoscopic display as naked-eye stereoscopic display properties; a disparity analyser adjusting the disparity calculated by the disparity calculator using the naked-eye stereoscopic display properties and a difference in disparity between a given pixel subject to processing and a peripheral pixel neighbouring the given pixel; a multi-viewpoint image generator generating a multi-viewpoint image by shifting each pixel of the paired left and right viewpoint images, using the disparity as adjusted by the disparity analyser; a viewpoint compositor compositing the multi-viewpoint image; and an output unit outputting a composite image obtained from compositing by the viewpoint compositor to the naked-eye stereoscopic display.

According to the above configuration, the naked-eye stereoscopic display properties and the difference in disparity between the pixel subject to processing and the peripheral pixel are both used by the disparity calculator to calculate and adjust the disparity. Thus, a multi-viewpoint image is generated with a disparity appropriate to the naked-eye stereoscopic display, enabling a user to view stereoscopic video with image fusion across the full screen without experiencing optical fatigue or stereoscopic fusion difficulties.

In another aspect, a multi-viewpoint image generation method generating a multi-viewpoint image for a naked-eye stereoscopic display, the multi-viewpoint image generation method comprising: an image acquisition step of acquiring paired left and right viewpoint images; a disparity calculation step of calculating a disparity between the paired left and right viewpoint images; a display properties storage step of storing a cross-talk rate or a recommended disparity for the naked-eye stereoscopic display as naked-eye stereoscopic display properties; a disparity adjustment step of adjusting the disparity calculated in the disparity calculation step using the naked-eye stereoscopic display properties; a multi-viewpoint image generation step of generating the multi-viewpoint image by shifting each pixel of the paired left and right viewpoint images, using the disparity as adjusted in the disparity adjustment step; a viewpoint composition step of compositing the multi-viewpoint image; and an output step of outputting a composite image, obtained through the compositing in the viewpoint composition step, to the naked-eye stereoscopic display.

According to this configuration, a multi-viewpoint image generation method is provided that enables a multi-viewpoint image to be generated with a disparity that is suited to the naked-eye stereoscopic display.

### Embodiment 1

An Embodiment of the disclosure is described below, with reference to the accompanying drawings.

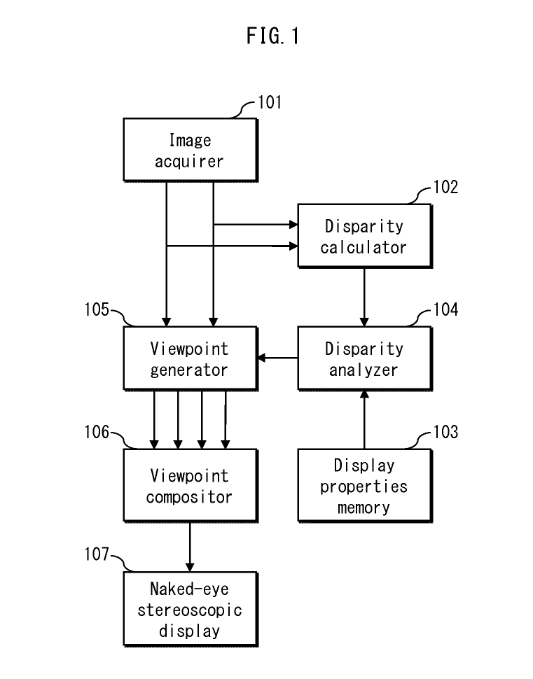

FIG. 1 illustrates the configuration of a multi-viewpoint image generation device pertaining to Embodiment 1. As shown, the multi-viewpoint image generation device includes an image acquirer 101, a disparity calculator 102, a display properties memory 103, a disparity analyser 104, a viewpoint generator 105, a viewpoint compositor 106, and a naked-eye stereoscopic display 107.

The image acquirer 101 receives paired left and right (hereinafter also L and R) stereo images in Blu-ray 3D, side-by-side, top-and-bottom, or similar format, separates out a left-view image (hereinafter also L-image) and a right-view image (hereinafter also R-image), and outputs the images to the disparity calculator 102 and the viewpoint generator 105.

The disparity calculator 102 calculates an inter-pixel distance for each pixel of the L and R images output by the image acquirer 101 using stereo image creation technology that employs graph cuts or a block matching method, such as the sum of absolute differences (hereinafter, SAD) or the sum of square differences (hereinafter, SSD). The disparity calculator 102 then respectively outputs an L-disparity map and an R-disparity map for the L-image and the R-image.

The display properties memory 103 stores naked-eye display properties, such as a cross-talk rate pertaining to the naked-eye stereoscopic display outputting a multi-viewpoint image, or a recommended disparity (i.e., for depth behind and protrusion ahead of the screen) pertaining to the naked-eye stereoscopic display, in a non-volatile or volatile memory. The disparity analyser 104 reads the display properties memory 103.

The disparity analyser 104 creates a disparity histogram and the like from the L-disparity map and the R-disparity map created by the disparity calculator 102, and uses the naked-eye stereoscopic display properties stored in the display properties memory 103 to calculate a disparity between optimal viewpoints of the naked-eye stereoscopic display. Afterward, the disparity analyser 104 converts the L-disparity map and the R-disparity map according to the calculated results and outputs the converted images to the viewpoint generator 105.

The viewpoint generator 105 performs a horizontal shift on the L-disparity map and the R-disparity map as adjusted for the naked-eye stereoscopic display and output by the disparity calculator 104, in accordance with the L and R images output by the image acquirer 101, the disparity, and the viewpoints, thereby generating viewpoint images in a quantity required by the naked-eye stereoscopic display 107.

The viewpoint compositor 106 composites the output of the viewpoint generator 105, which is a multi-viewpoint image, for display by the naked-eye stereoscopic display 107, and outputs the resulting composite image to the naked-eye stereoscopic display 107.

The naked-eye stereoscopic display 107 displays the composite image output by the viewpoint compositor 106 through a parallax barrier or a lenticular lens. Thus, naked-eye stereoscopic viewing is achieved.

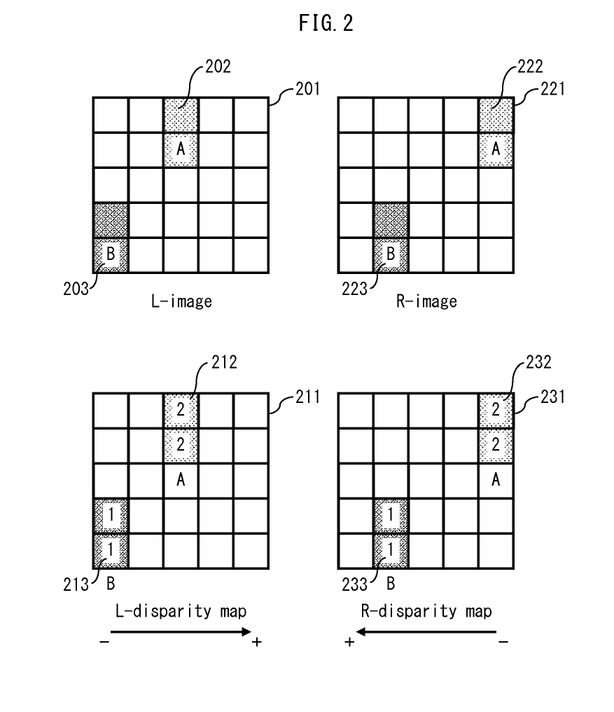

Next, the disparity calculator 102 is described with reference to FIG. 2. FIG. 2 illustrates an example of the disparity calculator 102 from FIG. 1. FIG. 2 depicts an L-image 201, object A 202 and object B 203 appearing in the L-image 201, an L-disparity map 211, object A 212 and object B 213 appearing in the L-disparity map 211, an R-image 221, object A 222 and object B 223 appearing in the R-image, an R-disparity map 231, and object A 232 and object B 233 appearing in the R-disparity map 231.

The L-image 201 shows object A 202 and object B 203, while the R-image 221 likewise shows object A 222 and object B 223. Here, a disparity of two exists for object A in the L-disparity map 211, given that object A 222 in the R-image 221 is displaced rightward by two pixels relative to the pixel position of object A 202 in the L-image 201. The relative positions of the objects are found using typical methods of block matching, such as SAD, SSD, or normalised cross-correlation (hereinafter, NCC).

Similarly, a disparity of one exists for object B 213 in the L-disparity map 211 corresponding to object B 203 in the L-image 201. In the L-image, the disparity is defined such that the rightward direction is positive and the leftward direction is negative. Similarly, the disparity in the R-image is defined such that the leftward direction is positive and the rightward direction is negative. As a result, in the R-disparity map 231, a disparity of two pixels corresponds to object A 232 and a disparity of one pixel corresponds to object B 233.

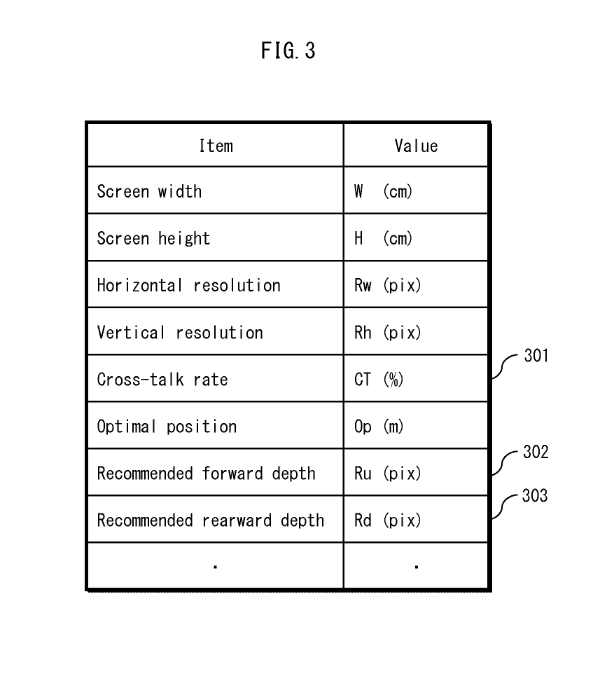

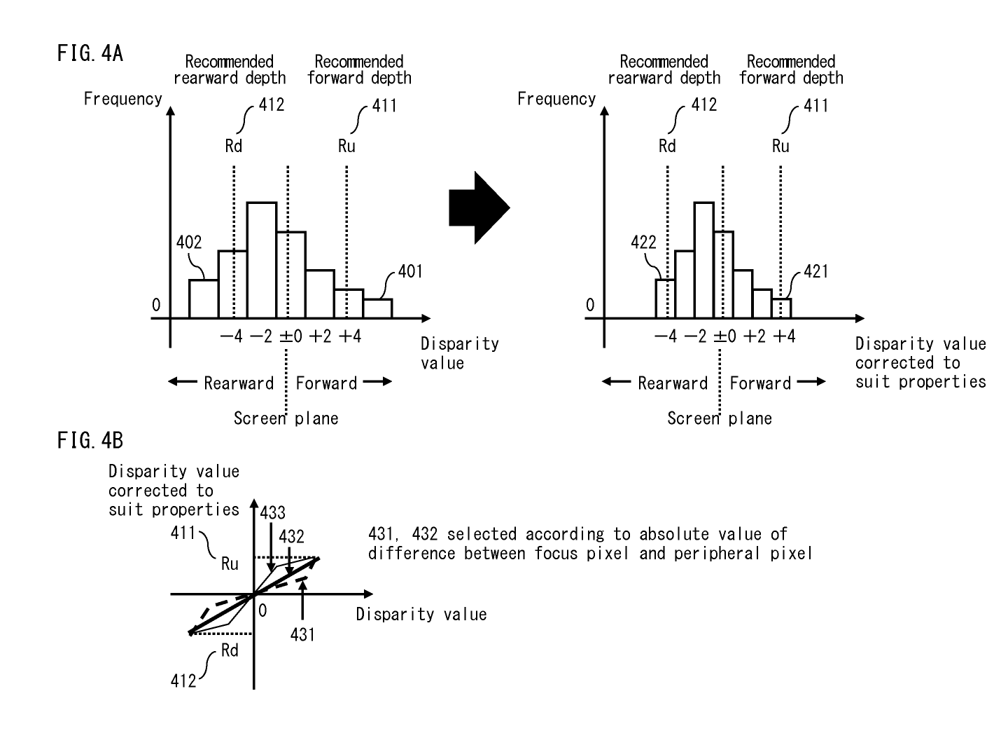

Next, the display properties memory 103 and the disparity analyser 104 are described with reference to FIGS. 3, 4A, and 4B. FIG. 3 illustrates an example of properties in the display properties memory 103 from FIG. 1. FIGS. 4A and 4B illustrate the operations of the disparity analyser 104 pertaining to Embodiment 1.

FIG. 3 depicts a cross-talk rate 301, a recommended forward depth 302, and a recommended rearward depth 303. The cross-talk rate 301 is a percentage of light intended for one eye (e.g., the right eye) seen in an image intended for the other eye (e.g., the left eye) when the stereoscopic image displayed on the display is viewed from the optimal position. For a multi-viewpoint image, the cross-talk rate represents a percentage of light seen from a given viewpoint that is intended for an image at another viewpoint. The cross-talk rate 301 is calculated by, for example, displaying a test image independently for each of the viewpoints in the multi-viewpoint image on the naked-eye stereoscopic display, and measuring the luminance of each test image using a luminance meter.

The recommended forward depth 302 is a disparity corresponding to the limit of visual fusion for a stereoscopic image protruding forward from the screen of the naked-eye stereoscopic display (with a zero-disparity between viewpoints) as seen from the optical position. Similarly, the recommended rearward depth 303 is a disparity corresponding to the limit of visual fusion for a stereoscopic image receding rearward into the screen.

The respective values of the recommended forward depth 302 and the recommended rearward depth 303 are obtained in advance by playing back various test images pertaining to disparity on a naked-eye stereoscopic display that has been adjusted in advance for the optimal position. Also, these values may be adjusted according to the contrast with surroundings, which may vary in practice.

FIG. 4A illustrates results of adjusting the disparity according to display properties. FIG. 4B is a graph of a disparity conversion formula. FIGS. 4A and 4B depict a maximum disparity 401, a minimum disparity 402, a recommended forward depth 411, a recommended rearward depth 412, an adjusted maximum disparity 421, an adjusted minimum disparity 422, and elements 431, 432, and 433 of a disparity conversion formula, applied to perform conversion in accordance an absolute value of a difference between a focus pixel and a peripheral pixel neighbouring the focus pixel. A positive disparity is perceived as protruding forward from the screen and a negative disparity is perceived as receding rearward into the screen.

The naked-eye stereoscopic display uses a range defined by the recommended forward depth Ru 411 and the recommended rearward depth Rd 412, evaluated in advance, to constrain the disparity such that fusion occurs for comfortable stereoscopic viewing from the optimal position. This is accomplished by using a linear transformation or the like to make a positive adjustment to the disparity, such that a distance between the maximum disparity 401 and the screen, where the disparity is zero, is equal to the recommended forward depth Ru 411, and then having the adjusted maximum disparity 421 match the recommended forward depth Ru 411. Similarly, the minimum disparity 402 is adjusted such that the adjusted minimum disparity 422 matches the recommended rearward depth Rd 412.

Specifically, the disparity analyser 104 acquires the largest disparity and the smallest disparity in the image, compares the acquired disparities to the respective recommended values (i.e., the recommended forward depth Ru and the recommended rearward depth Rd), and calculates a disparity adjustment coefficient from the result of comparison. Then, the disparity analyser 104 applies the disparity adjustment coefficient to the disparity for each pixel, thus modifying the disparity. Accordingly, a disparity between two viewpoints of an image is adjusted such that the disparity is constrained to a recommended disparity range for the naked-eye stereoscopic display.

FIGS. 3, 4A, and 4B illustrate an example of the multi-viewpoint image generation device pertaining to the present invention. However, no limitation to this configuration is intended.

For example, the disparity analyser 104 may use the cross-talk rate stored in the display properties memory 103 for the naked-eye stereoscopic display to adjust the disparity. Specifically, this involves taking a cross-talk rate of CT % for the optimal position according to the naked-eye stereoscopic display properties and a cross-talk rate of CT′ % estimated for the left and right viewpoints of the content acquired by the image acquirer 101 (e.g., Blu-ray 3D created for use with active-shutter 3D glasses), finding the proportion of the cross-talk rate relative to the recommended forward depth or to the recommended rearward depth, and computing the disparity adjustment coefficient from the ratio between the cross-talk rates (i.e., CT/CT′ (where CT<CT′). Then, the disparity analyser 104 applies the disparity adjustment coefficient to the disparity for each pixel, thus converting the disparity.

Also, instead of using the maximum disparity and the minimum disparity, a top X % and a bottom Y % of a disparity histogram may be found using the p-tile method, and the disparity may be adjusted such that a span between the recommended forward depth and the recommended rearward depth matches a span between the top X % and the bottom Y % of the disparity calculated by the disparity calculator 102.

Specifically, the disparity analyser 104 acquires the top X % and the bottom Y % of the disparity in an image, compares the top X % and the bottom Y % of the disparity to the respective recommended disparities (i.e., the recommended forward depth Ru and the recommended rearward depth Rd), and calculates the disparity adjustment coefficient as the ratio of these disparities.

The disparity is adjusted such that the span of recommended disparity values for the naked-eye stereoscopic display is constrained within the top X % and the bottom Y % of the disparity. As such, a multi-viewpoint image is generated with a disparity appropriate for the naked-eye stereoscopic display. Also, when a protrusion value is present in the 3D content, the disparity is made appropriately adjustable without affecting the protrusion value of the disparity.

Furthermore, the values of X and Y are dynamically modifiable according to the surface area (i.e., the number of pixels) of the screen periphery (i.e., the zero-disparity vicinity). Specifically, the values of X and Y may be larger when the surface area of the screen periphery is large, and may be smaller when the surface area of the screen periphery is small.

Adjusting the disparity in the surface area of the screen periphery is effective given that, over the entire screen, a wide surface area is available for fusion and as such, the presence of a portion with strong disparity is not likely to be noticed within the screen as a whole.

Also, the values of X and Y are dynamically modifiable according to an amount of displacement between consecutives frame in one or two views in images acquired from the image acquirer 101 showing paired left and right viewpoints. Specifically, the X and Y values are larger when there is a large amount of displacement between frames, and are smaller when there is a small amount of displacement between frames.

When there is a large amount of motion between consecutive frames, the presence of a portion with strong disparity is not likely to be noticed within the screen as a whole. Thus, adjusting the disparity in response to the amount of displacement between frames enables adjustments to the disparity that are more appropriate for the user.

Also, when optimising the disparity, an adjustment to the disparity may be made by evaluating the disparity at a pixel subject to processing (i.e., the focus pixel) and at neighbouring pixels, and taking the average of the disparities so evaluated. Specifically, the adjustment is applied locally, on the disparity adjusted using the naked-eye stereoscopic display properties, and in response to the difference between the respective disparities of the pixel subject to processing and pixels in the vicinity thereof. Further, the difference is intensified when the difference between the respective disparities of the pixel subject to processing and the pixels in the vicinity thereof is less than a predetermined value, and is weakened when the difference between the respective disparities of the pixel subject to processing and pixels in the vicinity thereof is more than a predetermined value.

This is an extension of dynamic range compression technology, which is based on the properties of human vision. In essence, the range of constraint is between recommended forward depth and the recommended rearward depth. However, the goal is to locally enhance the effect of dynamic compression. The disparity contrast is adjustable according to the difference in disparity between the pixel subject to processing and the neighbouring pixels thereof. Thus, a multi-viewpoint image is produced with intensified solidity.

For example, the disparity conversion formula 432 of FIG. 4B is adjustable through conversion to disparity conversion formula 431 or to disparity conversion formula 432, according to the absolute value of the difference in disparity between the target pixel and a peripheral pixel. For example, supposing that the absolute value of the difference in disparity between a target pixel and a peripheral pixel is critical to the sense of stereoscopy, the local disparity contrast is enhanced by using disparity conversion formula 431 to weaken the stereoscopy when the absolute value difference is high, and by using disparity conversion formula 433 to strengthen the stereoscopy when the absolute value difference is low. As such, disparity adjustment suitable for the naked-eye stereoscopic display properties is made possible. Although this example describes using the absolute value of the disparity between the focus pixel and the peripheral pixel, no such limitation is intended. Any simple difference may be used in order to perform a local adjustment by converting the discrepancy according to a degree to which a focus pixel is ahead of or behind (i.e., distance in terms of depth) the peripheral pixel.

Similarly, supposing that the user is sensitive to stereoscopic solidity in a focus region of the screen being viewed and is insensitive to the stereoscopic solidity in a peripheral region distant from the focus region, then local adjustment to the disparity may be made using not only the absolute value of the difference in disparity between the focus pixel and the peripheral pixel, but also in accordance with a distance from the centre of a region of interest (e.g., a central position in a pixel group having near-zero disparity). For example, when a given pixel is located near the central point of a region of interest, a local disparity adjustment is performed to weaken the difference between the given pixel and the peripheral pixel so as to prevent double-imaging. Likewise, when the given pixel is distant from the centre of the region of interest, a local disparity adjustment is performed to strengthen the difference between the given pixel and the peripheral pixel.

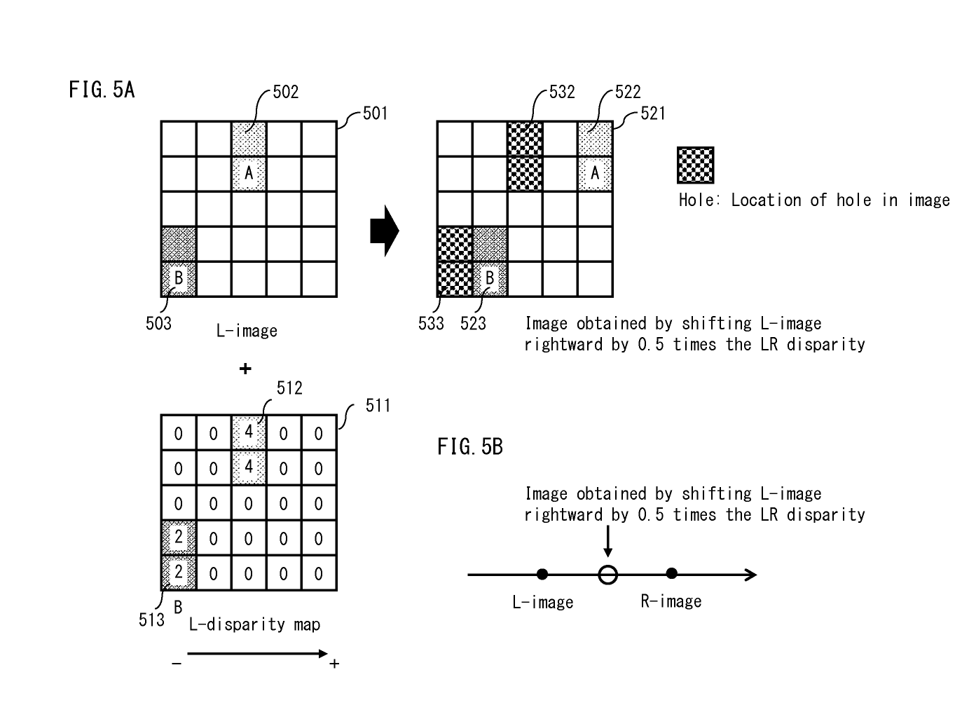

Next, the viewpoint generator 105 is described with reference to FIGS. 5A and 5B. FIGS. 5A and 5B illustrate an example of the operations of the viewpoint generator 105 from FIG. 1. FIG. 5A depicts an L-image 501, object A 502 and object B 503 appearing in the L-image 501, an L-disparity map 511, object A 512 and object B 513 appearing in the L-disparity map 511, a shifted image 521 obtained by shifting the L-image 501 rightward by 0.5 times the LR disparity, object A 522 and object B 523 appearing in the shifted image 521, and holes 532 and 533 appearing in the image.

The example of FIG. 5A shows the L-image 501 and the L-disparity map 511 being used to generate a viewpoint at a position shifted rightward from the L-image by 0.5 times the LR disparity. The LR disparity represents a disparity between the L-image and the R-image acquired from the image acquirer 101. In this example, the LR disparity is precisely equivalent to the viewpoint position at the centre of the camera that captured the L-image and the R-image.

Here, object A 502 appearing in the L-image has a disparity of four relative to object A 512 appearing in the L-disparity map 511. Accordingly, the rightward shift by 0.5 times the LR disparity involves shifting object A 502 rightward by 4×0.5=2 pixels, into object A 522. Similarly, object B 503 appearing in the L-image has a disparity of two, and thus the rightward shift by 0.5 times the LR disparity involves shifting object B 503 rightward by one pixel, into object B 523.

Here, shifting the pixels of the L-image 501 in entirety according to the L-disparity map 511 produces the holes 532 and 533 occurring in the pixels. These holes correspond to occlusions that are visible in the L-image but not in the R-image. An appropriate value must be used to fill the holes. For instance, given that a background at infinite distance is viewed identically from any viewpoint, a pixel in the vicinity of the hole may be found, and the colour of a corresponding background having low disparity may be obtained to fill the hole.

FIGS. 5A and 5B illustrate an example of Embodiment 1, and this configuration need not necessarily be employed. For example, in FIGS. 5A and 5B, the viewpoint generator is configured to shift the viewpoint rightward from the L-image. However, a leftward shift may also be used, or vertical shift may be used instead of the horizontal shift to generate a new viewpoint. That is, a viewpoint image may be generated using any horizontal or vertical shift, based on the stereo image of the L-image or of the R-image.

Also, although FIGS. 5A and 5B illustrate shifting each pixel horizontally or vertically to generate the new viewpoint image, this configuration need not necessarily be used. For instance, the viewpoint may be generated not by shifting pixel units, but rather by using a SHIFT or SURF method in advance to find characteristic points or the like, calculating a relative point, and using perspective projection or the like on each of a plurality of polygonal regions joining the characteristic points for the viewpoint conversion. Here, no holes occur as the characteristic points all match.

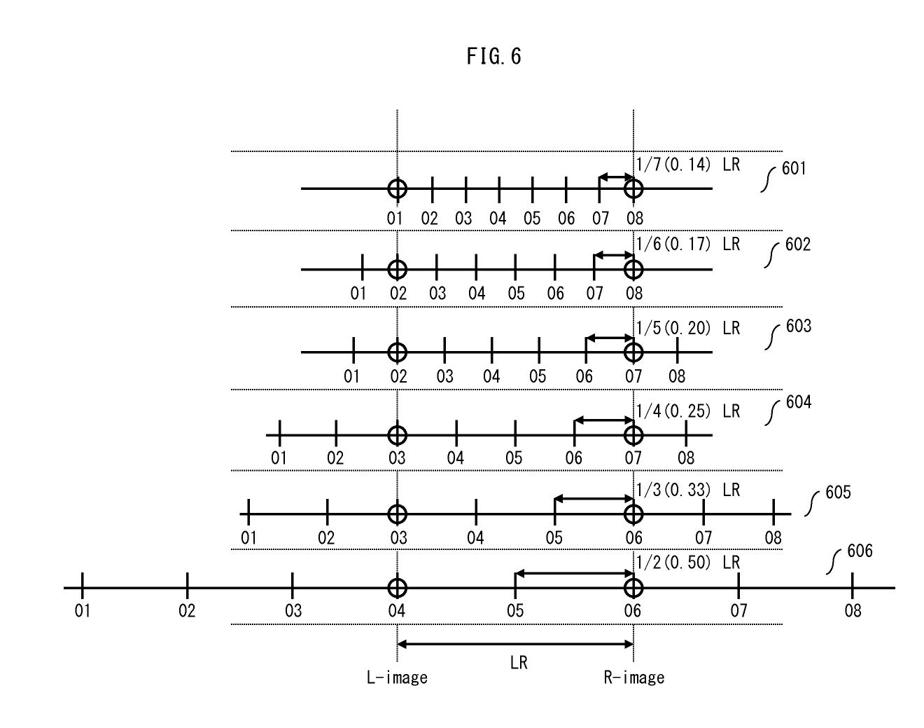

Next, an example is given, with reference to FIG. 6, of high-quality viewpoint generation and image creation by the viewpoint generator of FIG. 1 actively using the paired L and R images. FIG. 6 illustrates the viewpoint generator 105 using the analysis results of the disparity analyser 104 to determine a factor for applying to the disparity value of each viewpoint as a multiple of the LR disparity between the L-image and the R-image as generated by the image acquirer 101 of FIG. 1. The disparity value between viewpoints is then used in this example for multi-viewpoint generation, producing eight viewpoints as viewpoint images 01 through 08. The viewpoint generator 105 selects a multi-viewpoint image generation pattern according to the factor used by the disparity analyser 104 when adjusting the disparity, then uses the selected multi-viewpoint image generation pattern to generate the multi-viewpoint images.

For example, when the disparity analyser 104 has produced an analysis such that the viewpoints are to be generated with a factor of 0.30, the viewpoint generator 105 selects pattern 604, which has a disparity factor of 0.25 that is thus slightly lower than the factor 0.30 resulting from the disparity analyser 104. Next, the eight viewpoint images 01 through 08 are generated using the selected pattern, such that each viewpoint image is generated with a disparity of 0.25×n (where is a position-dependant variable). Here, the original L-image is used as viewpoint image 03 and the original R-image is used as viewpoint image 07. Viewpoint images 04, 05, and 06 are thus between the L-image and the R-image. At this stage, disparity analyser 104 solely serves to analyse the ideal disparity between viewpoints.

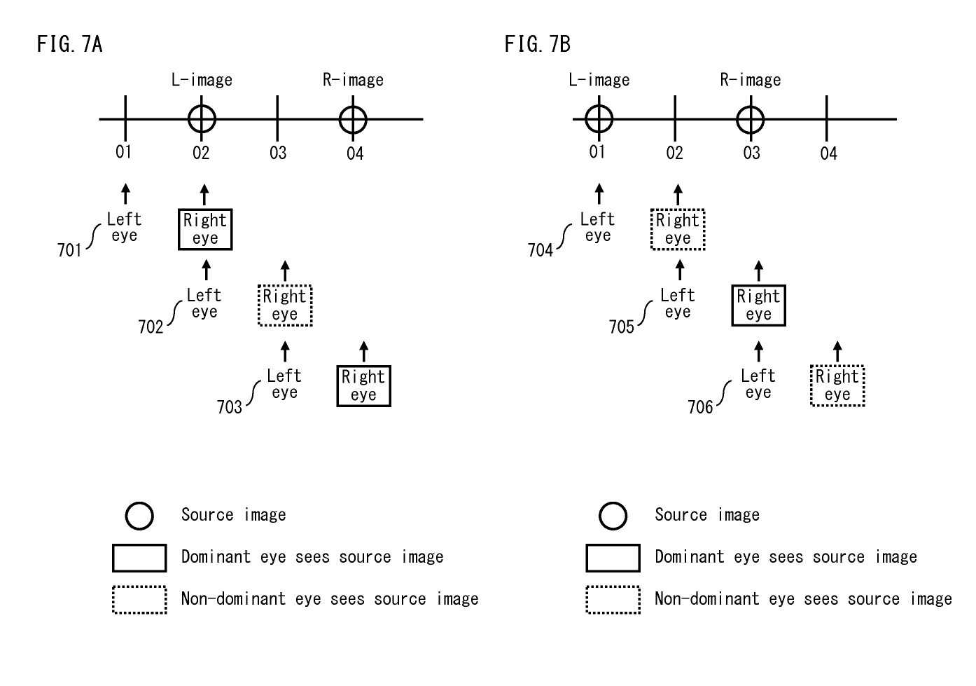

Next, an example of viewpoint generation that takes dominant eyes into consideration is given with reference to FIGS. 7A and 7B.

FIGS. 7A and 7B illustrate an example including four viewpoint images generated with a viewpoint disparity of 0.50LR. In this example, the right eye is the dominant eye. FIG. 7A illustrates an ideal image seen by the dominant right eye when no noise is present, at position 701 viewing viewpoint images 01 and 02 and at position 703 viewing viewpoint images 03 and 04 such that the dominant eye corresponds to a source image. Likewise, FIG. 7B illustrates an ideal image seen by the dominant right eye when no noise is present, at position 705 viewing viewpoint images 02 and 03 such that the dominant eye corresponds to a source image. As such, when four viewpoint images are generated, the patterns shown in FIGS. 7A and 7B are produced. However, the viewpoint generator 105 referencing dominant eye information for the user may instead select a multi-viewpoint image generation pattern such that the user's dominant eye more frequently corresponds to one of the paired left and right images.

When the number of viewpoints is even and an odd number of viewpoints are located between the L-image and the R-image, or conversely, when the number of viewpoints is odd and an even number of viewpoints are located between the L-image and the R-image, two multi-viewpoint image generation patterns are possible. However, using dominant eye information configured in advance using a remote control or the like enables viewpoint creation such that the dominant eye sees the L and R source images, thereby providing a naked-eye stereoscopic environment in which stereoscopic image fusion is more easily achieved over the entire screen. The dominant eye selection method may also be implemented automatically by retrieving information pertaining to a user's dominant eye, this information having been registered in advance using face recognition technology or the like.

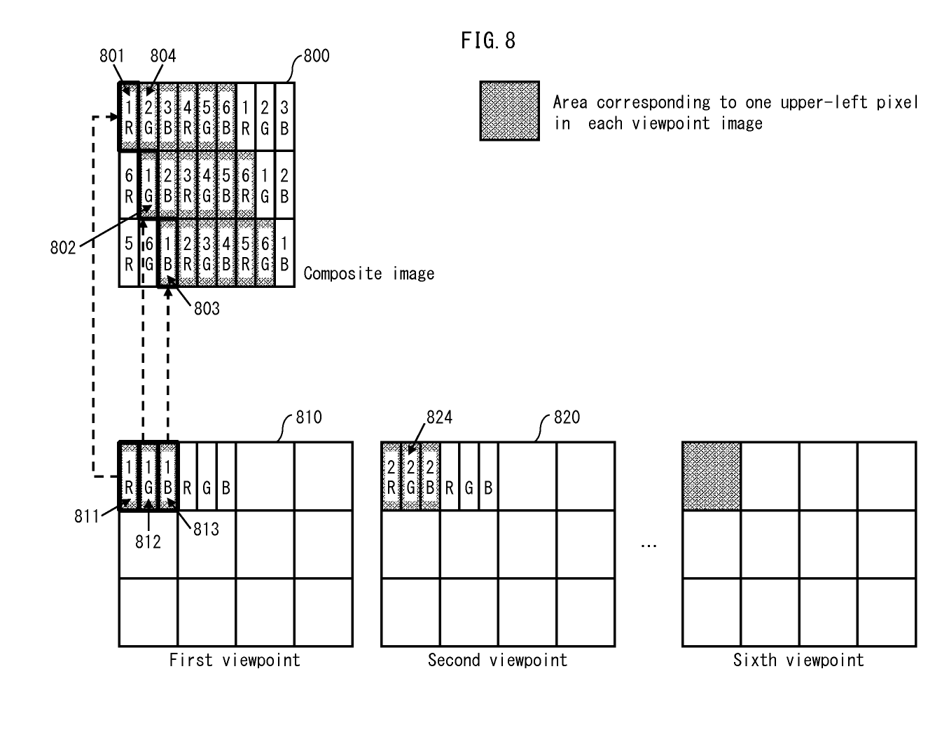

Next, the viewpoint compositor 106 is described with reference to FIG. 8. FIG. 8 depicts an example of the viewpoint compositor 106 operating when the naked-eye stereoscopic display 107 of FIG. 1 uses a six-viewpoint parallax barrier. Here, the parallax barrier has holes for six viewpoints formed as sub-pixel units, and thus must involve compositing sub-pixel units. As such, the sub-pixels of each viewpoint are filled in according to sub-pixel RGB order. For example, an upper-left sub-pixel 801 in a composite image 800 is filled in to correspond to an R-component upper-left sub-pixel 811 of a first viewpoint image 810. Next, sub-pixel 804 adjacent to the upper-left sub-pixel 801 in the composite image 800 is filled in to correspond to a G-component upper-left sub-pixel 824 of a second viewpoint image 820. Also, sub-pixel 812 corresponding to a G-component upper-left sub-pixel of the first viewpoint image 810 is filled in to correspond to a G-component of the second row of the composite image 800, and sub-pixel 813 corresponding to a B-component upper-left sub-pixel of the first viewpoint image 810 is filled in to correspond to a B-component of the third row of the composite image 800. As such, with respect to the resolution of the composite image, the viewpoint images are reduced horizontally according to the ratio of the number viewpoints to the number of sub-pixels (e.g., 3), and are reduced vertically according to the number of sub-pixels (e.g., 3). This enables the composite image 800 to be produced by acquiring the sub-pixels in order for composition. The composition illustrated in FIG. 8 is intended as an example. Other configurations are also applicable. For example, with respect to the resolution of the composite image, individual viewpoint images may be prepared by performing reduction according to the number of viewpoints and filling in by sub-pixel units, or the viewpoint images may be expanded according to the vertical resolution (such that the composite image and the viewpoint images match in terms of vertical position).

The operations of the multi-viewpoint image generation device configured as described above are described next.

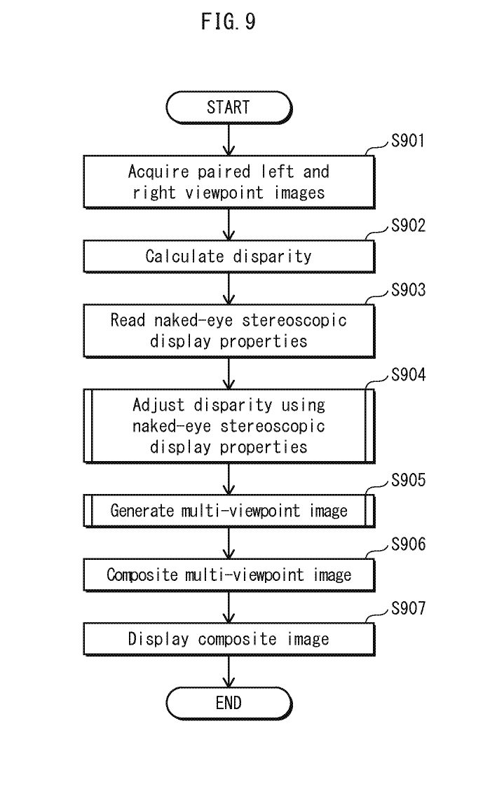

FIG. 9 is a flowchart illustrating the overall operations performed by a multi-viewpoint image generation device pertaining to the present disclosure.

According to the flowchart, the image acquirer 101 first acquires the paired left and right viewpoint images (step S901).

Next, the disparity calculator 102 calculates the disparity between the two viewpoints acquired by the image acquirer 101, namely the paired L and R images (step S902). Specifically, the disparity calculator 102 calculates an inter-pixel distance for each pixel of the paired L and R images output by the image acquirer 101 using stereo image creation technology that employs graph cuts or a block matching method, such as SAD or SSD, and then outputs an L-disparity map and an R-disparity map for the L-image and the R-image.

Next, the disparity analyser 104 reads the naked-eye stereoscopic display properties stored in the display properties memory 103 (step S903).

Then, the disparity analyser 104 uses the naked-eye stereoscopic display properties so read to adjust the disparity calculated by the disparity calculator 102 (step S904). The details of the disparity adjustment process are discussed later.

Next, the viewpoint generator 105 generates a multi-viewpoint image using the disparity as adjusted by the disparity analyser 104 (step S905). The details of the multi-viewpoint image generation process are discussed later.

Next, the viewpoint compositor 106 composites the multi-viewpoint image generated by the viewpoint generator 105 (step S906).

Then, the viewpoint compositor 106 outputs the composite image obtained by the compositing performed in step S906 to the naked-eye stereoscopic display 107, which displays the composite image (step S907).

This concludes the description of the multi-viewpoint image generation device operations. The details of the disparity adjustment performed in step S904 are described next.

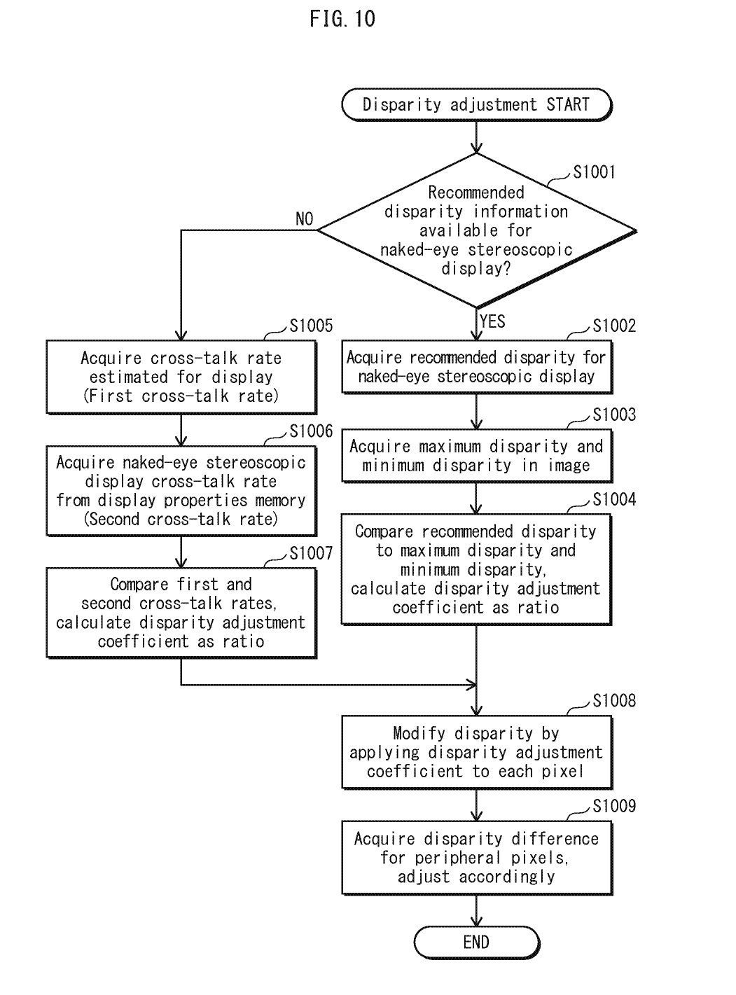

FIG. 10 is a flowchart of the detailed disparity adjustment process.

As shown, the disparity analyser 104 determines whether information pertaining to a recommended disparity for the naked-eye stereoscopic display is stored in the display properties memory 103 (step S1001).

In the affirmative case (YES in step S1001), the disparity analyser 104 acquires the recommended disparity for the naked-eye stereoscopic display from the display properties memory 103 (step S1002).

The disparity analyser 104 then acquires a maximum disparity and a minimum disparity from within the image (step S1003).

The disparity analyser 104 then compares the recommended disparity to a difference between the maximum disparity and the minimum disparity, and calculates a disparity adjustment coefficient by taking the ratio thereof (step S1004).

When the result of step S1001 is negative (NO in S1001), the disparity analyser 104 acquires a cross-talk rate (i.e., a first cross-talk rate) for a typical stereoscopic display (e.g., a BD-3D-compatible stereoscopic display), supposing that the two viewpoint images acquired by the image acquirer 101 are displayed thereon (S1005).

The disparity analyser 104 then acquires a cross-talk rate for the naked-eye stereoscopic display (i.e., a second cross-talk rate) from the display properties memory 103 (step S1006).

Next, the disparity analyser 104 compares the first cross-talk rate to the second cross-talk rate, and calculates a disparity adjustment coefficient by taking the ratio thereof (step S1007).

Once step S1004 or step S1007 is complete, the disparity analyser 104 applies the disparity adjustment coefficient to the disparity for each pixel, thus modifying the disparity (step S1008). Accordingly, a disparity between two viewpoints of an image is adjusted such that the disparity is constrained to a recommended disparity range for the naked-eye stereoscopic display.

Afterward, the disparity analyser 104 acquires a difference in disparity between a processing target pixel and a peripheral pixel, then carries out a local adjustment to the disparity in accordance with this difference, in addition to the adjustment performed according to the display properties (step S1009). Specifically, the difference is intensified when the difference between the respective disparities of the pixel subject to processing and pixels in the vicinity thereof is less than a predetermined value, and is weakened when the difference between the respective disparities of the pixel subject to processing and pixels in the vicinity thereof is more than a predetermined value.

This concludes the description of the details of the disparity adjustment performed in step S904. The details of the multi-viewpoint image generation process performed in step S905 are described next.

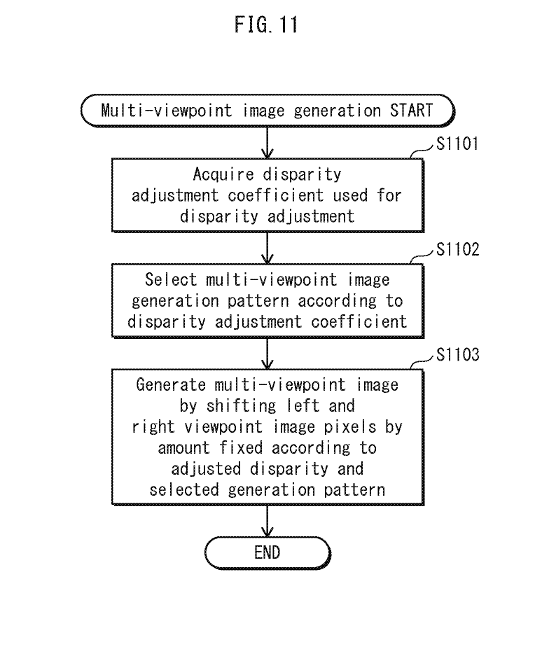

FIG. 11 is a flowchart of the details of the multi-viewpoint image generation process.

As shown, the viewpoint generator 105 acquires the disparity adjustment coefficient used in the disparity adjustment (step S1101).

Next, the viewpoint generator 105 selects a multi-viewpoint image generation pattern in accordance with the acquired disparity adjustment coefficient (step S1002).

The viewpoint generator 105 then shifts the pixels of the two viewpoint images by an amount determined according to the disparity as adjusted by the disparity analyser 104 and according to the selected viewpoint image generation pattern, thus generating the multi-viewpoint image (step S1103).

This concludes the description of the details of the multi-viewpoint image generation process performed in step S905.

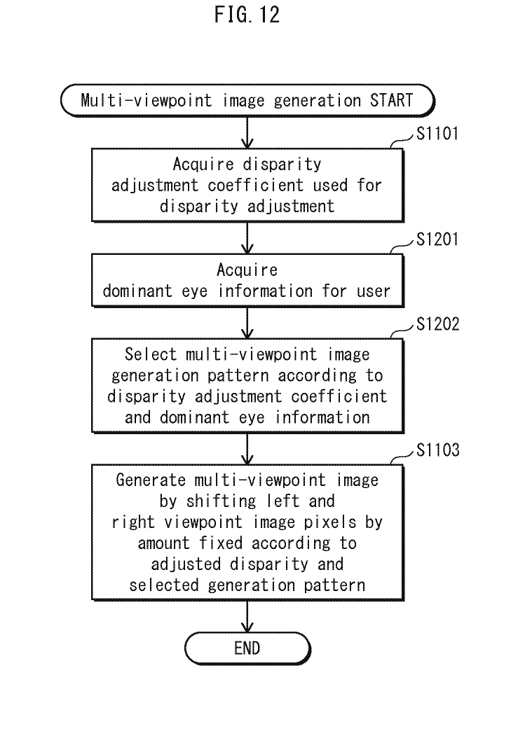

In addition, FIG. 12 describes a Variation of the above-described multi-viewpoint image generation process. Here, after the disparity adjustment coefficient used in the disparity adjustment has been acquired (step S1101), the viewpoint generator 105 acquires dominant eye information for the user (step S1201). The dominant eye information is stored in non-volatile or volatile memory, and is read by the viewpoint generator 105 from the memory.

Next, the viewpoint generator 105 uses the disparity adjustment coefficient and the dominant eye information to select the multi-viewpoint image generation pattern (step S1202). Accordingly, a multi-viewpoint image generation pattern is selected that ensures the user's dominant eye is made to view the left and right source images more often, within the multi-viewpoint image.

### Embodiment 2

A multi-viewpoint image generation device pertaining to Embodiment 2 differs from the multi-viewpoint image generation device pertaining to Embodiment 1 in that a depth map representing a depth of each pixel in the two viewpoint images is first acquired, and the acquired depth map is used to generate the multi-viewpoint image.

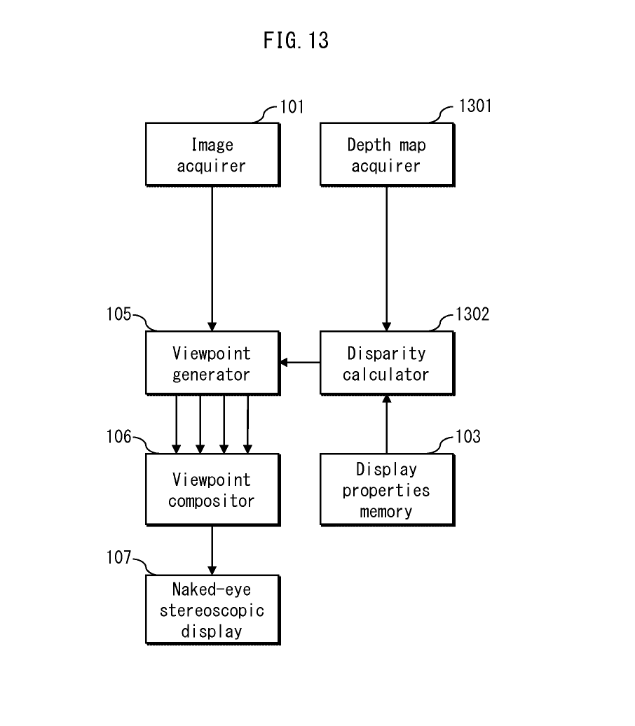

FIG. 13 illustrates the configuration of a positioning processing device pertaining to Embodiment 2. FIG. 13 uses the same reference signs as FIG. 1 wherever applicable, and explanations of the pertinent components are omitted. FIG. 13 depicts a depth map acquirer 1301 that acquires a depth map input from an outside source, and transmits the depth map to the disparity analyser 1302. For example, content created using computer graphics or the like includes three-dimensional model data. Thus, accurate three-dimensional depth information is easily obtained and is usable for the simple creation of a depth map within the content. Alternatively, a distance sensor such as a time-of-flight (hereinafter, TOF) sensor may be used simultaneously acquire a greyscale image and the depth map.

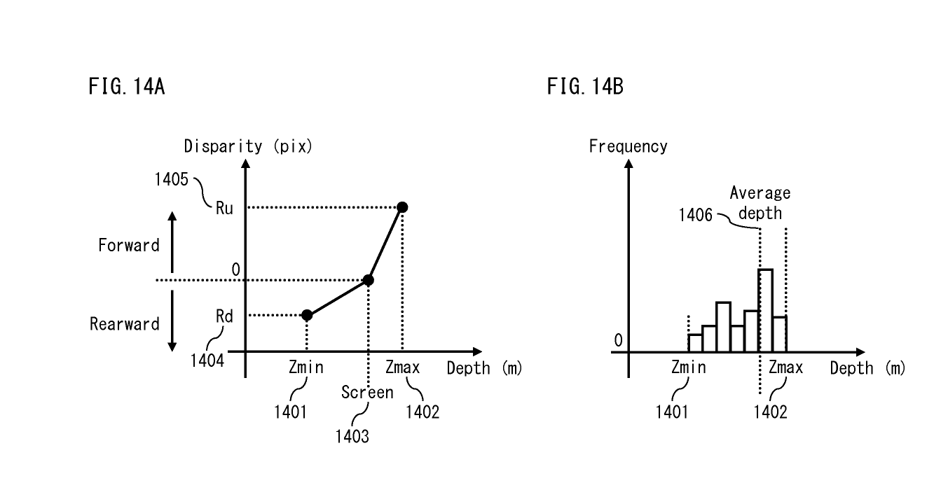

Here, the depth map output by the depth map acquirer 1301 does not include the inter-pixel disparity of the L-image and the R-image as used in Embodiment 1, but rather contains three-dimensional depth information acquired from CG models, a TOF sensor, or the like. Accordingly, the disparity analyser 1302 must convert the depth information corresponding to the pixel values in the depth map into a range of disparity values for the recommended rearward depth and the recommended forward depth requested by the display properties memory 103. FIGS. 14A and 14B illustrate a simple Variation.

FIGS. 14A and 14B depict an example of converting the depth map into disparity values. FIGS. 14A and 14B show a minimum depth 1401 in the depth map, a maximum depth 1402 in the depth map, a zero-depth 1403 corresponding to the screen surface (i.e., zero disparity), a recommended rearward depth 1404, a recommended forward depth 1405, and an average depth 1406. In this example, the disparity analyser 1302 converts the minimum depth 1401 into the recommended rearward depth 1404, and converts the maximum depth 1402 into the recommended forward depth 1405. The disparity analyser 1302 also allocates the zero-depth 1403 within the average depth 1406, and uses a linear transformation in each interval to convert the depth values into disparity values.

FIGS. 14A and 14B illustrate a non-limiting example. Further methods for converting the depth map into disparity values include converting a local disparity by using a focus pixel and a neighbouring pixel in the depth information, as described in the explanation of the disparity analyser 104 with reference to FIG. 4.

As shown in FIG. 13, once the disparity analyser 104 outputs the disparity image converted from the optimal depth for the naked-eye stereoscopic display, the viewpoint generator 105 proceeds to generate a plurality of viewpoints based on the image acquired by the image acquirer and on the disparity image, the viewpoint compositor then compositing the viewpoints and the naked-eye stereoscopic display 107 displaying the result, as described in Embodiment 1.

The operations of the multi-viewpoint image generation device pertaining to Embodiment 2 and configured as described above are described next.

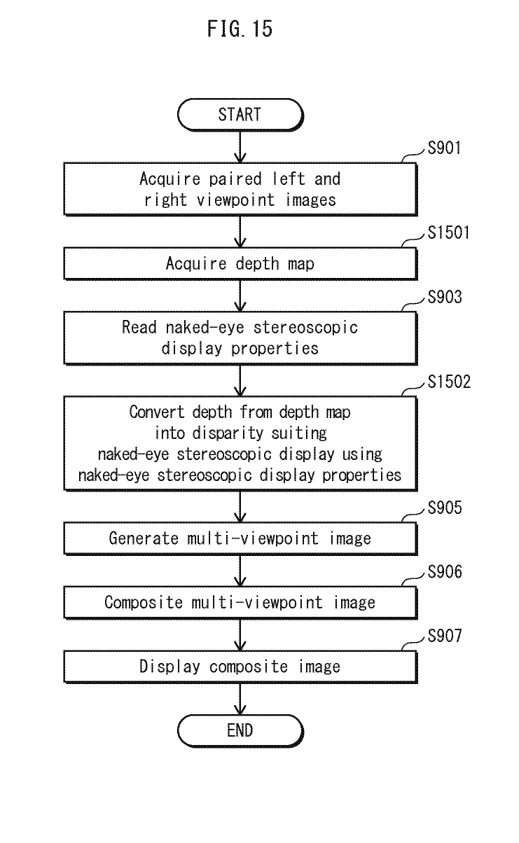

FIG. 15 is a flowchart illustrating the overall operations performed by a multi-viewpoint image generation device pertaining to Embodiment 2. Portions of the operations identical to those performed by the multi-viewpoint image generation device pertaining to Embodiment 1 and described in FIG. 9 use the same reference signs thereas.

Once the paired left and right viewpoint images have been acquired (step S901), the depth map acquirer 1201 acquires the depth map (step S1501).

Then, once the naked-eye stereoscopic display properties have been read (step S903), the disparity calculator 1302 uses the naked-eye stereoscopic display properties to convert the depth values indicated in the depth map into disparity values appropriate to viewing on the naked-eye stereoscopic display (step S1502).

The processing of steps S905, S906, and S907 is performed after step S1502 is complete.

This concludes the description of the multi-viewpoint image generation device operations pertaining to Embodiment 2.

(Variations)

The present disclosure has been described above in terms of the Embodiments. However, no limitation is intended to the Embodiments described above. The following Variations are also included in the scope.

[a] In the present disclosure, the operations described in the Embodiments may be realised by having an application realise the functions thereof. Also, a computer program including codes causing a computer to execute the operations may be used.
[b] In the present disclosure, large-scale integration (hereinafter, LSI) may be used to control the multi-viewpoint image generation device described above in the Embodiments. Such an LSI is able to realise the functions of the disparity calculator 102, the disparity analyser 103, and the other functional blocks via integration. The functional blocks may be realised as independent chips, or alternatively, a single chip may include all or a subset of the functional blocks.

Although LSI is mentioned above, the terms integrated circuit (hereinafter, IC), system LSI, super LSI, or ultra LSI may be more appropriate, depending on the degree of integration.

Also, the method of integration is not limited to LSI. A dedicated circuit or a general-purpose processor may be used. After LSI assembly, a FPGA (Field Programmable Gate Array) or reconfigurable processor may be used.

Furthermore, should progress in the field of semiconductors or emerging technologies lead to replacement of LSI with other integrated circuit schemes, then such technology may of course be used to integrate the functional blocks. Biotechnology applications and the like are also possible.

[c] The present disclosure may be implemented as a digital television, mobile telephone terminal, personal computer, or other three-dimensional image displaying device that features the multi-viewpoint image generation device described in the above Embodiments. Additional options include a BD player, DVD player, or similar playback device that features the multi-viewpoint image generation device described in the above Embodiments.
[d] In the above-described Embodiments, once the disparity has been adjusted using the naked-eye stereoscopic display properties, a further adjustment is made locally, according to a difference in disparity between a pixel subject to processing and a peripheral pixel neighbouring the pixel subject to processing. However, no such limitation is intended. The disparity adjustment using the naked-eye stereoscopic display properties may be performed simultaneously alongside the local adjustment made in accordance with the difference in disparity. That is, the naked-eye stereoscopic display properties and the difference in disparity between the pixel subject to processing and the peripheral pixel may be used to make the adjustment pertaining to the disparity calculation by the disparity calculator 102.
[e] The above-described Embodiments and Variations may be freely combined.

### INDUSTRIAL APPLICABILITY

The viewpoint generation device pertaining to the present disclosure is applicable to enabling the realisation of naked-eye stereoscopy by adjusting a disparity between viewpoints according to naked-eye stereoscopic display properties such that image fusion occurs across a full screen.

### REFERENCE SIGNS LIST

101 Image acquirer
102 Disparity calculator
103 Display properties memory
104 Disparity analyser
105 Viewpoint generator
106 Viewpoint compositor
107 Naked-eye stereoscopic display
201 L-image
202 Object A in L-image
203 Object B in L-image
211 L-disparity map
212 Object A in L-disparity map
213 Object B in L-disparity map
221 R-image
222 Object A in R-image
223 Object B in R-image
231 R-disparity map
232 Object A in R-disparity map
233 Object B in R-disparity map
301 Cross-talk rate
302 Recommended forward depth
303 Recommended rearward depth
401 Maximum disparity
402 Minimum disparity
411 Recommended forward depth
412 Recommended rearward depth
421 Adjusted maximum disparity
422 Adjusted minimum disparity
431, 432, 433 Disparity conversion method elements
501 L-image
502 Object A in L-image
503 Object B in L-image
511 L-disparity map
512 Object A in L-disparity map
513 Object B in L-disparity map
601, 602, 603, 604, 605, 606 Viewpoint generation patterns
701 Viewpoints 01 and 02 as viewed in one generation pattern
702 Viewpoints 02 and 03 as viewed in one generation pattern
703 Viewpoints 03 and 04 as viewed in one generation pattern
704 Viewpoints 01 and 02 as viewed in another generation pattern
705 Viewpoints 02 and 03 as viewed in another generation pattern
706 Viewpoints 03 and 04 as viewed in another generation pattern
800 Composite image
801 R-component upper-left sub-pixel for composite image
802 G-component upper-left sub-pixel 1 for composite image
803 B-component upper-left sub-pixel for composite image
804 G-component upper-left sub-pixel 2 for composite image
810 First viewpoint image
811 R-component upper-left sub-pixel for first viewpoint image
812 G-component upper-left sub-pixel for first viewpoint image
813 B-component upper-left sub-pixel for first viewpoint image
820 Second viewpoint image
824 G-component upper-left sub-pixel for second viewpoint image
1301 Depth map acquirer
1302 Disparity analyzer
1401 Minimum depth of depth map
1402 Maximum depth of depth map
1403 Depth at screen surface
1404 Recommended rearward depth
1405 Recommended forward depth
1406 Average depth

1-16. (canceled)

17. A multi-viewpoint image generation device generating a multi-viewpoint image for a naked-eye stereoscopic display, the multi-viewpoint image generation device comprising:
an image acquirer acquiring paired left and right viewpoint images;
a disparity calculator calculating a disparity between the paired left and right viewpoint images;
a display properties memory storing a cross-talk rate or a recommended disparity for the naked-eye stereoscopic display as naked-eye stereoscopic display properties;
a disparity analyser adjusting the disparity calculated by the disparity calculator using the naked-eye stereoscopic display properties;
a multi-viewpoint image generator generating the multi-viewpoint image by shifting each pixel of the paired left and right viewpoint images, using the disparity as adjusted by the disparity analyser;
a viewpoint compositor compositing the multi-viewpoint image; and
an output unit outputting a composite image, obtained through the compositing by the viewpoint compositor, to the naked-eye stereoscopic display.

18. The multi-viewpoint image generation device of claim 17, wherein
the disparity analyser further performs, on a given pixel, a local adjustment to the disparity as adjusted using the naked-eye stereoscopic display properties, according to a difference in disparity between the given pixel and a peripheral pixel in the vicinity of the given pixel.

19. The multi-viewpoint image generation device of claim 18, wherein
in the local adjustment, the disparity analyser intensifies the difference in disparity when the difference in disparity between the given pixel and the peripheral pixel in the vicinity of the given pixel is less than a predetermined value, and weakens the difference in disparity when the difference in disparity between the given pixel and the peripheral pixel in the vicinity of the given pixel is greater than the predetermined value.

20. The multi-viewpoint image generation device of claim 17, wherein
the disparity analyser adjusts the disparity such that a span of the disparity calculated by the disparity calculator between a top X % and a bottom Y % is constrained within a range of the recommended disparity for the naked-eye stereoscopic display.

21. The multi-viewpoint image generation device of claim 20, wherein
the disparity analyser varies a value of X and a value of Y in accordance with a quantity of pixels having a near-zero disparity.

22. The multi-viewpoint image generation device of claim 20, wherein
the disparity analyser varies a value of X and a value of Y in accordance with an amount of inter-frame motion in one or both of the paired left and right viewpoint images.

23. The multi-viewpoint image generation device of claim 17, wherein
the disparity analyser adjusts the disparity such that a respective maximum value and minimum value of the disparity calculated by the disparity calculator are constrained within the range of the recommended disparity for the naked-eye stereoscopic display.

24. The multi-viewpoint image generation device of claim 17, wherein
the image acquirer acquires a first cross-talk rate estimated for a case where the paired left and right viewpoint images are displayed on a typical stereoscopic display, and
the disparity analyser compares the first cross-talk rate to a second cross-talk rate stored in the display properties memory for the naked-eye stereoscopic display, and adjusts the disparity according to a ratio of the first cross-talk rate and the second cross-talk rate.

25. The multi-viewpoint image generation device of claim 17, wherein
the disparity analyser computes a factor for applying a multiplication to the disparity calculated by the disparity calculator, such that the span of the disparity between the top X % and the bottom Y % is constrained within the range of the recommended disparity for the naked-eye stereoscopic display, and
the multi-viewpoint image generator uses the factor computed by the disparity analyser to make a selection from among a plurality of multi-viewpoint image generation patterns employing the paired left and right viewpoint images as a portion of the multi-viewpoint image, and generates the multi-viewpoint image using the selected multi-viewpoint image generation pattern.

26. The multi-viewpoint image generation device of claim 25, wherein
the multi-viewpoint image generator references dominant eye information for a user, and makes the selection of the multi-viewpoint image generation pattern such that within the multi-viewpoint image, the paired left and right viewpoint images are more frequently allocated as viewpoint images corresponding to a dominant eye for the user.

27. The multi-viewpoint image generation device of claim 17, wherein
the disparity analyser sets a centre of interest at a central position in a pixel group having a near-zero disparity calculated by the disparity calculator, and performs the local disparity adjustment in accordance with a distance from the centre of interest to the given pixel subject to processing.

28. A multi-viewpoint image generation device generating a multi-viewpoint image for a naked-eye stereoscopic display, the multi-viewpoint image generation device comprising:
an image acquirer acquiring paired left and right viewpoint images;
a depth map acquirer acquiring a depth map indicating a depth for individual pixels of the paired left and right viewpoint images;
a display properties memory storing a cross-talk rate or a recommended disparity for the naked-eye stereoscopic display as naked-eye stereoscopic display properties;
a disparity analyser adjusting a disparity between the paired left and right viewpoint images defined by the depth indicated in the depth map, using the naked-eye stereoscopic display properties;
a multi-viewpoint image generator generating a multi-viewpoint image by shifting each pixel of the paired left and right viewpoint images, using the disparity as adjusted by the disparity analyser;
a viewpoint compositor compositing the multi-viewpoint image; and
an output unit outputting a composite image obtained from compositing by the viewpoint compositor to the naked-eye stereoscopic display.

29. The multi-viewpoint image generation device of claim 28, wherein
the disparity analyser further performs, on a given pixel, a local adjustment to the disparity as adjusted using the naked-eye stereoscopic display properties, according to a difference in disparity between the given pixel and a peripheral pixel in the vicinity of the given pixel.

30. The multi-viewpoint image generation device of claim 28, wherein
the disparity analyser adjusts the disparity such that a span of the disparity defined by the depth indicated in the depth map between the top X % and a bottom Y % is constrained within a range of the recommended disparity for the naked-eye stereoscopic display.

31. A multi-viewpoint image generation device generating a multi-viewpoint image for a naked-eye stereoscopic display, the multi-viewpoint image generation device comprising:
an image acquirer acquiring paired left and right viewpoint images;
a disparity calculator calculating a disparity between a left viewpoint and a right viewpoint, from the paired left and right viewpoint images;
a display properties memory storing a cross-talk rate or a recommended disparity for the naked-eye stereoscopic display as naked-eye stereoscopic display properties;
a disparity analyser adjusting the disparity calculated by the disparity calculator using the naked-eye stereoscopic display properties and a difference in disparity between a given pixel subject to processing and a peripheral pixel neighbouring the given pixel;
a multi-viewpoint image generator generating a multi-viewpoint image by shifting each pixel of the paired left and right viewpoint images, using the disparity as adjusted by the disparity analyser;
a viewpoint compositor compositing the multi-viewpoint image; and
an output unit outputting a composite image obtained from compositing by the viewpoint compositor to the naked-eye stereoscopic display.

32. A multi-viewpoint image generation method generating a multi-viewpoint image for a naked-eye stereoscopic display, the multi-viewpoint image generation method comprising:
an image acquisition step of acquiring paired left and right viewpoint images;
a disparity calculation step of calculating a disparity between the paired left and right viewpoint images;
a display properties storage step of storing a cross-talk rate or a recommended disparity for the naked-eye stereoscopic display as naked-eye stereoscopic display properties;
a disparity adjustment step of adjusting the disparity calculated in the disparity calculation step using the naked-eye stereoscopic display properties;
a multi-viewpoint image generation step of generating the multi-viewpoint image by shifting each pixel of the paired left and right viewpoint images, using the disparity as adjusted in the disparity adjustment step;
a viewpoint composition step of compositing the multi-viewpoint image; and
an output step of outputting a composite image, obtained through the compositing in the viewpoint composition step, to the naked-eye stereoscopic display.
